(19) United States
(12) Patent Application Publication
(10) Pub. No.: US 2022/0282344 A1
(43) Pub. Date: Sep. 8, 2022

(54) METHOD AND TABLE FOR CUTTING RAW LEATHER WITH OPTIMIZED GEOMETRY

(71) Applicant: JBS S/A, São Paulo, SP (BR)

(72) Inventor: Roberto MOTTA DA SILVA, São Paulo, SP (BR)

(21) Appl. No.: 17/632,292

(22) PCT Filed: Sep. 23, 2020
(86) PCT No.: PCT/BR2020/050376

§ 371 Date: Feb. 2, 2022

(51) Int. Cl. C14B 17/04; C14B 5/00

(52) U.S. Cl. CPC C14B 17/04; C14B 5/00; C14B 2700/11

(57) ABSTRACT

The present invention discloses a method for cutting raw or tripe leather with an optimized geometry, which increases the yield of the original raw or tripe leather (A) piece for all the production chain, concomitantly reducing the quantity of solid residues, since the cutting is carried out prior to the tanning stage. Said method is made possible by the use of a cutting table (C) which comprises a top (10) in trapezoid shape, with a plurality of metallic strips (20) juxtaposed in parallel, longitudinally at the lateral ends of the referred top (10). The claimed method has sustainable characteristics and reduces the environmental impact that is inherent to the leather industry, since it enables the use of the generated coproducts, of collagenic constitution, in the food or pharmaceutical industry, reducing the discard of residues in the environment.

### FIELD OF THE INVENTION

The present invention belongs to the technical field of mechanical processing of animal skins, more particularly it presents a method and an apparatus for cutting skins (leathers) from bovines, which enables obtaining a leather piece with optimized geometry, applicable in the initial stage of the production process, aiming at leveraging aspects related to environmental sustainability and economic efficiency for the production chain.

### STATE OF THE ART DESCRIPTION

Leather is the skin of animal origin that is preserved by the tanning process, and has been used by man for centuries as a base material for manufacturing several artifacts for daily use, there existing records about the making of sandals from this material, dated before the Christian era.

The leather industry depends on the beef cattle and the slaughterhouses, which provide their main raw material, and participate in different production chains, producing inputs for the clothing, footwear, furniture, sports, artifacts and auto industries. In view of the collagenic property of leather, it also contributes as a base product for the food, pharmaceutical and cosmetic industries, among others.

The cow hide is the one most used worldwide, since it is the most plentiful in the market and, consequently, presents the lowest cost. The second one most used is the goatskin, however, the search for leathers originating from pigs, sheep as well as from other animal species, such as reptiles (alligators and snakes) and, more recently, amphibians (frogs) and fishes has increased.

The leather, although it is recognized as a natural and noble material, is considered a subproduct by the slaughterhouses, since the main products in the livestock activity are the meat and dairy products.

The leather industry moves millions of dollars per year, and Brazil occupies a prominent position in the worldwide scenario, as holder of one of the largest herds of cattle.

One of the biggest problems presented by the leather production chain refers to the environmental impact in the processing process of the same.

Therefore, the optimization of the production process is one of the main challenges of the leather industry, to enhance the quality and the economic return of the product, allying sustainable practices and which reduce the environmental impact.

There exist some proposals in the state of the art for methods of cutting leather, as will be demonstrated.

Document WO2014/162249, for example, claims a method for cutting finished leathers in pre-defined parts, which will be used in the making of consumer goods.

Document US20060207444, describes a turntable cutting table, which optimizes the necessary physical space for the leather cutting work stations of the automotive segment.

There further exist non-patentary documents which help in the understanding of the social, economic and environmental aspect of the leather industry and are important to mention for a better comprehension of the present application, namely:

National Bank for Economic and Social Development

The tanning industry in Brazil. Sector report. Industrial area, no. 3, October/2007. Available at:

http://www.bndes.gov.br/SiteBNDES/export/sites/default/bndes pt/Galerias/Arquivos/conhecimento/setorial/informe-03AI.pdf

Brazilian Agency for Industrial Development

ABDI. Sector Monitoring Report—Leather Industry. March/2011. Available at:

http://old.abdi.com.br/Estudo/CouroRelat%C3%B3rio%/20de%20A companhamento%20Setorialmar%C3%A7o2011vers%C3%A3o%20eletr%C3% B4nica.pdf%20copypdf

As demonstrated, the state of the art presents some alternatives to optimize leather cutting, however, none of them comes close to the scope proposed by the method of the present invention, which adds sustainable characteristics and reduces the environmental impact.

For the purposes of the terminology in this document, “leather” is understood as being the cow hide in all the production stages thereof, from the removal from the animal in the slaughterhouse to the tanned and finished product, destined to the final consumer of the production chain.

### Objectives of the Invention

One of the objectives of the present invention consists in a differentiated method for leather cutting, carried out prior to the tanning step, which may be applied to the skins in the so-called raw or green leather state, as well as to the state known as tripe or limed, providing obtaining a leather piece with a differentiated geometry relative to the traditional standards, which presents a more uniform fibrillar structure, higher homogeneity and, consequently, better use of the product which will be used as raw material in several industries which use leather as input.

Said method is operationalized with the use of a cutting table having a trapezoid shape, with a plurality of metallic strips arranged in parallel, longitudinally at their lateral ends, which form slots that allow the precise cutting of the raw leather or tripe leather, where the cutting operator is guided by colored markers or, optionally, by alphanumeric characters, which enable obtaining a piece that is cut in a symmetric and uniform manner.

The proposed method provides the increase in the leather piece yield obtained with the use thereof throughout the production chain, since the resulting cutting area can be better used, given its physical and geometrical characteristics, which concomitantly, reduces the quantity of solid residues generated, as well as the reduction of the use of chemical compounds. Since the cutting is carried out prior to the tanning step, which enables the use of the residues generated, in the form of leather scraps, having collagenic constitution, for the food or pharmaceutical industry, among others, thus adding environmental sustainability and economic characteristics to the proposed method.

### SUMMARY OF THE INVENTION

The method, object of the present invention, allows a better use of the leather by means of the cutting of the animal skin with a specific geometry, still in the initial stages of production, and may be applied to skins in the stage called raw hide or green, or even in the stage called tripe or limed.

As a way to put the described method into practice, there is used in the cutting process of the raw leather or tripe leather piece, a table having a trapezoid top, with a plurality of metallic strips which juxtaposition forms slots, arranged in parallel, longitudinally at their lateral ends, which allows a precise and symmetric cut of the leather pieces with any dimension, where the cutting operator is guided by colored markers or with alphanumeric characters.

The method now described allows obtaining a leather piece with a better use of the more noble parts of the skin, in a shape that allows better packaging, transport and handling, as well as a lower final weight, which results in optimization of the costs associated to the logistics of the product, generating a lower carbon footprint for the logistics chain, both in road transport as in maritime transport, as well as adding sustainability to the entire production chain, since the leather scraps which would be discarded after the impregnation with tanning substances, are separated with the material still in natural stage, and can be reused in the food or pharmaceutical industry, given their collagenic nature.

### BRIEF DESCRIPTION OF THE DRAWINGS

The characteristics of the present invention will become apparent from the detailed description thereof, which must be analyzed together with the example drawings which accompany this report, where:

FIG. 1—shows a flow diagram, containing the traditional steps of the leather production process;

FIG. 2—shows a flow diagram with the method proposed by the present invention inserted in the steps of the leather production chain.

FIG. 3—shows a raw bovine hide piece with the indication of the areas of the piece that are involved in the cutting process;

FIG. 4—shows an example of a bovine leather piece in raw or tripe stage, and the resulting leather piece in the cutting process, with a minimum geometry proposed by the present invention;

FIG. 5—shows an example of a bovine leather piece in raw or tripe stage, and the resulting piece of raw leather from the cutting process, with a maximum geometry proposed by the present invention;

FIG. 6—shows a front elevated perspective view of the cutting table of the present invention;

FIG. 7—shows a rear elevated perspective view of the cutting table of the present invention;

The figures presented are schematic and of a particular embodiment of the invention, which dimensions and proportions are not necessarily real, since they only have the purpose of didactically presenting their several aspects, which protection coverage will be determined by the scope of the attached claims.

### DETAILED DESCRIPTION OF THE INVENTION

In order to be used in the preparation of any product, the skin must go through several treatment processes, from the moment when it is removed from the animal, until it is ready for use, to maintain the fibrous nature thereof and avoid the degradation and consequent putrefaction.

The processing comprises a series of steps and operations, and begins in slaughterhouses with the skinning, which consists in the removal of the animal skin.

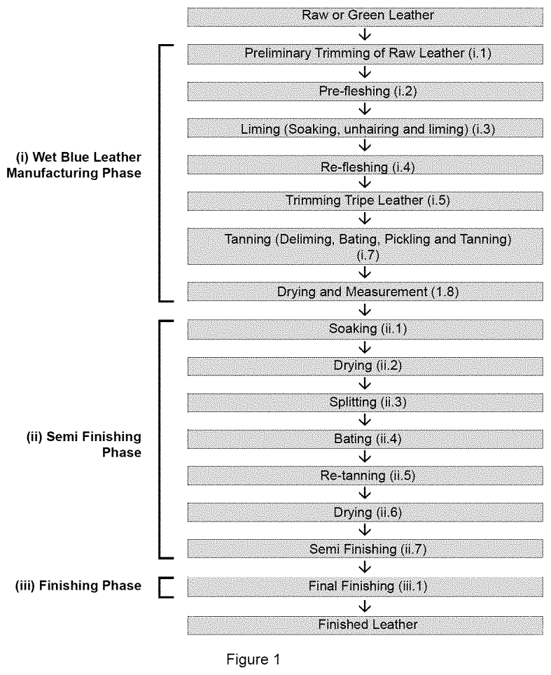

After obtaining the skin in slaughterhouses, the leather production process, as illustrated in FIG. 1, presents the following phases and operations:
(i) Wet Blue leather manufacturing phase (Tanning)
(i.1) Preliminary trimming of the raw hide
(i.2) Pre-fleshing
(i.3) Liming (Soaking, unhairing and liming)
(i.4) Re-fleshing
(i.5) Tripe leather trimming
(i.6) Splitting
(i.7) Tanning (Deliming, Bating, Pickling and Tanning)
(i.8) Drying and Measurement
(ii) Semi-Finishing Phase
(ii.1) Soaking
(ii.2) Drying
(ii.3) Splitting
(ii.4) Bating
(ii.5) Re-tanning
(ii.6) Drying
(ii.7) Semi Finishing
(iii) Finishing Phase
(iii.1) Final Finishing

By means of the reaction of chemical agents, such as the Monobasic Chromium Sulfate, used in the tanning process to provide thermal stability to the leather and resistance to decomposition, the leather piece in this step achieves a gray-blue color, and for this reason it is called wet blue leather.

A common alternative to the wet blue tanning is the wet white method, where synthetic tannins, vegetable tannins, glutaraldehydes or minerals (such as aluminum and zirconium), can be used, which are less aggressive to the environment.

In the usual commercialization geometry, the original raw or tripe leather (A) piece originating from the skinning process, has all the characteristics of the original shape of the animal from which it was extracted, where the positioning of the head, front/back legs, belly can be clearly perceived, apart from several burrs on the ends of the piece, known as shavings.

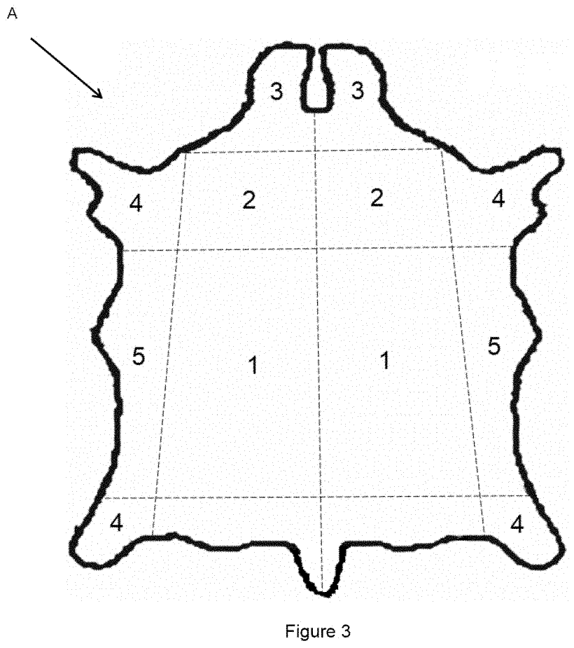

The original raw or tripe leather (A) piece has its ends cut in several stages of the production process, since, for the most part, they cannot be totally used for a single commercial purpose. However, said cuts do not alter substantially the geometry of the original raw or tripe leather (A) piece, as shown in FIG. 3, comprised of regions named as breech or loin (1), shoulder (2), neck or head (3), feet (4) and belly (5).

Since it is a product of organic origin, the fibrillar structure of the leather is not uniform throughout all the area thereof. In this manner, different regions of the leather have different aspects of mechanical resistance, tactile and even visual. The most central regions of the leather piece, such as the loin (1) and the shoulder (2) have more compact fibers and more resistance, being considered more noble and destined to articles which require better quality. On the other hand, the more flacid ends, such as the head (3), feet (4) and belly (5) have a more open fibrillar structure, being considered as having less added value to the leather industry in general, without however, depreciation of the value thereof for the food and/or pharmaceutical industries.

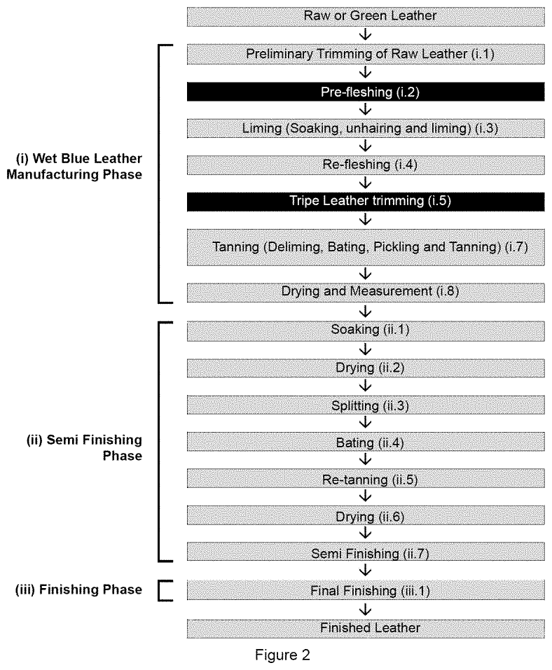

In the method proposed by the present invention, shown in FIG. 2, there is applied to the original raw or tripe leather (A) piece a cut which provides it with a geometry wherein the resulting raw or tripe leather piece (B) is obtained, wherein the areas referring to the head (3), feet (4) and belly (5) can be partially or totally removed, still in the initial phase of the leather production process, in the Manufacturing Phase of the Wet Blue Leather, and may be applied to skins in the state where it is called raw leather or green leather, in the Pre-Fleshing process (i.2), or in the stage called tripe leather, in the process of Tripe Leather Trimming (i.5), wherein the hairs, flesh and fatty residues have already been completely removed.

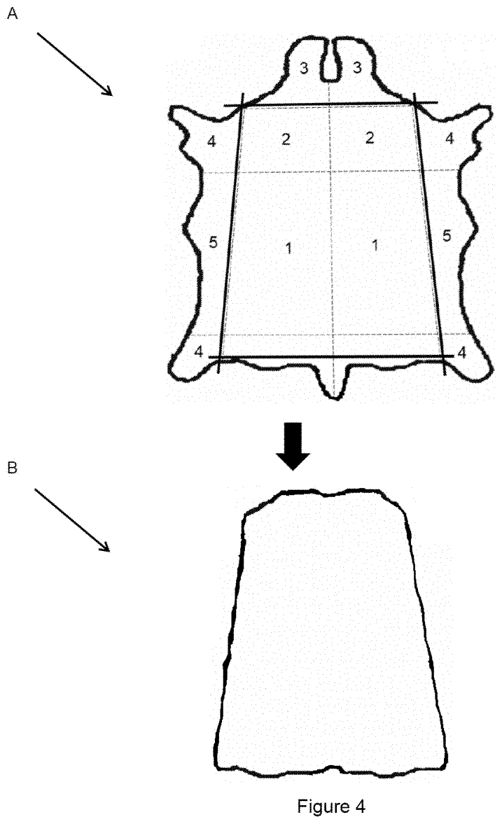

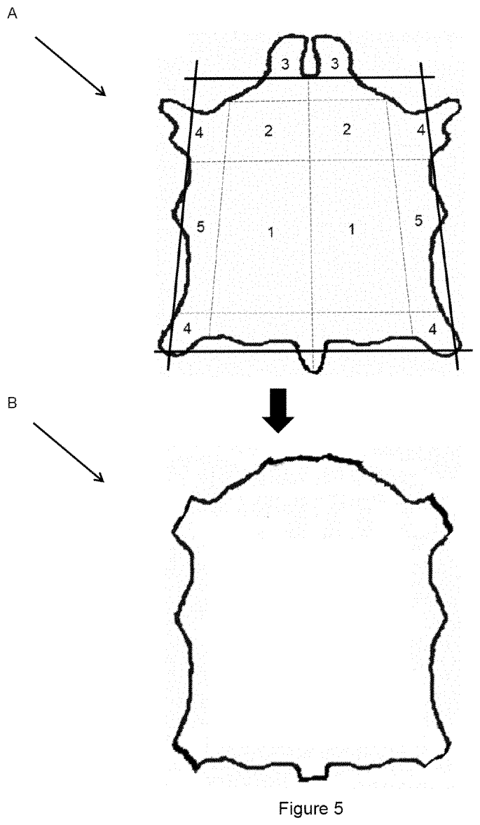

The resulting raw or tripe leather piece (B) of the present cutting method has a homogeneous visual aspect and functional characteristics that are completely diverse from those commonly found in the state of the art for this initial production phase (Manufacturing Phase of Wet Blue Leather), as can be seen in FIGS. 4 and 5, wherein the leather pieces with more added value, the loin (1) and the shoulder (2), are privileged, in detriment of the remaining pieces, namely: head (3), feet (4) and belly (5); which, due to their intrinsic characteristics such as fibrillar structure and distribution/size of the hair follicles and pores, present low added value, not being suitable for, for example, making noble articles.

The cutting method now described comprises a range which can vary between a minimum and a maximum geometry.

In the referred minimum geometry, the head (3), feet (4) and belly (5) are completely removed, generating a resulting raw or tripe leather piece (B) with smaller dimensions.

In the referred maximum geometry, the head (3), feet (4) and belly (5) are partially removed, generating a resulting raw or tripe leather piece (B) with larger dimensions.

Among the improved functional characteristics of the resulting raw or tripe leather piece (B), is obtaining a leather piece with a substantially trapezoid geometry or quadrangular, without the usual irregularities presented on the edges of the original raw or tripe leather (A) piece, which provides a better use of the product, in general.

Another improved functional characteristic of the resulting raw or tripe leather piece (B) obtained with the method now described, is the lower standard deviation of the break variable in the product. This variable represents the firmness of the fibrillar structure of the leather, that is, how uniform is the aspect of the upper layer of the leather, called the grain within the same skin in its different regions.

Obtaining a resulting raw or tripe leather piece (B) with a lower standard deviation of the break variable in relation to the leather pieces originally provided in the Manufacturing Phase of Wet Blue Leather, is a fundamental characteristic to justify the use of the method proposed by the present invention, since it promotes the generation of a final piece with higher value added characteristic in a homogeneous manner, which, consequently, increases the production yield. This is one of the decisive aspects in the product meeting the final specifications, and gains in this sense also represent significant optimization of the chain from the point of view of quality and variability of the product.

The shavings or leather coproducts originating from the proposed method, since they are obtained in steps prior to tanning, were not submitted to the action of chemical substances, such as chromium, which is still intensively used in the Wet Blue manufacturing stage.

In this manner, the shavings removed from the original raw or tripe leather (A) piece, according to the present method, can be totally destined to the food sector industries, for the manufacture of gelatin for example, as well as to the pharmaceutical or cosmetic industries, which are great collagen consumers.

In the conventional process, the leather regions maintained in the Wet Blue Manufacturing Phase, are to a large extent removed in subsequent stages, due to the requirements of cuts that are inherent to the process as a whole, however, since they are already impregnated with inorganic compounds (including metals such as Chromium) and several other chemical products, they are discarded in landfills specifically prepared for this purpose which, when not correctly administrated long-term, can become great environmental hazards.

Among the common steps in the leather manufacturing process, is the Splitting step (i.6, ii.3), which has as objective the splitting of a leather piece, reducing the thickness thereof to allow the processing of the leather in final steps of product finishing. A subsequent shaving process (ii.4) will leave the tanned leather piece precisely in the desired thickness.

The splitting can occur in a leather factory in the wet blue stage (i.6), or in a leather factory in the semifinished stage (ii.3). In the first case, the splitting is carried out still in the tripe stage, wherein the leather has not been tanned yet and which lower part of the splitting (shaving) can still be directed to the food sector. One alternative to the process would be to carry out the splitting in a semifinished leather factory (ii.3), wherein the tanned shaving can become, for example, suede, used in the footwear and clothing industry.

The cutting method, as described, is made possible by means of a cutting table, specifically developed for this purpose.

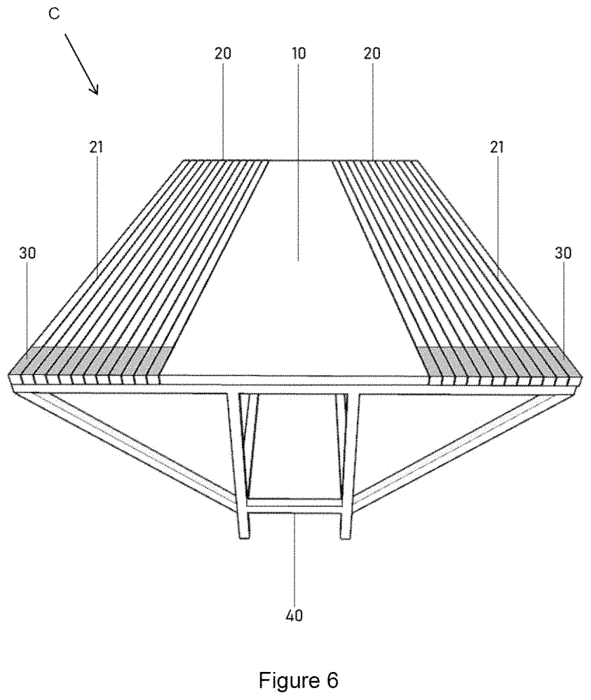

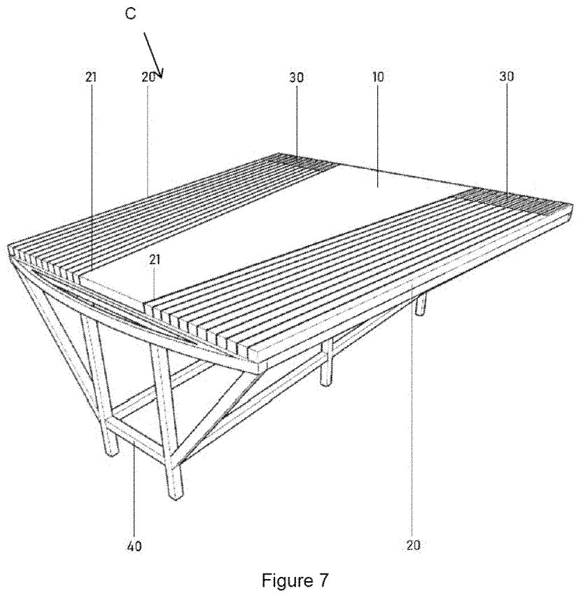

The cutting table (C) used in this method, as illustrated in FIGS. 6 and 7, comprises a top (10), in trapezoid shape, supported by a support structure (40), with the referred top (10) presenting a plurality of metal strips (20) juxtaposed in parallel, longitudinally at their lateral ends, each metallic strip (20) being positioned on a determined side having a pair on the diametrically opposed side of the top (10) of the cutting table ((C).

Each pair of metallic strips (20), diametrically opposite, is identified with markers (30) of the same color or optionally with the same characters or digits, to allow the alignment and symmetrical cut of an original raw or tripe leather (A) piece over the top (10).

The gaps formed by the meeting of the metallic strips (20), form slots (21), which serve as guide for the cutting knifes, whether they are manual or pneumatic, which with the help of the markers (30), enable the symmetrical cut of the original raw or tripe leather (A) piece in several sizes.

In a preferred embodiment, the cutting table (C) is integrally produced in stainless steel, having the top (10) in isosceles trapezoid, presenting approximately 2.70 m length, 1.80 m smaller width and 0.82 m height. The metallic strips (20), which can vary in number from 10 to 15, present approximate width of 5 mm, allowing the cutting process with the help of manual or pneumatic knives.

The sustainability aspect, reached by the method that is the object of the present invention, can be quantified by the substantially superior generation of raw leather coproducts, which are destined to the food industry, for example. While in a conventional process the generation of same is around 1.90% over the weight of the leather, in the instant process this generation is of approximately 23%, that is, a difference of 21.10 percent points or 1.210%. Leathers produced in this manner are, thus, much better used in terms of quantity of coproducts generated and of the minimization of the generation of potentially toxic residues for the environment.

The sustainability aspect is also present in subsequent steps of the leather production chain. In this production chain, in a general manner, one of the most important aspects of the process is the cutting yield, which refers to the percentage of useful area used in pieces cut over the total area of the leather. There exists an inherent loss to the process, since some areas are not used, particularly those positioned at the ends and between the main pieces.

In contrast, with the new cutting geometry proposed by the present invention, the leather presents a superior use according to the segment where the product will be manufactured. Tests in the automotive leather industry have shown a minimum improvement of 3% in the cutting yields, which means a lower generation of residues, destined to landfills in the same order of magnitude. Further, being significantly lower the carbon footprint that the leather carries while being processed according to the new cutting geometry proposed.

In summary, during the production chain, the leather products go through the following industrial processing units:
1—Slaughterhouse;
2—Wet Blue stage leather factory;
3—Semifinished stage leather factory; and
4—Final finishing and leather cutting factory.

In this manner, considering that the method proposed is carried out in the leather factory in the Wet Blue stage, all the movement of the leather carried out therefrom weighs and occupies a volume which is around 20% lower in comparison with the conventional process, found in the state of the art, which translates into a lower leather mass to be transported by road or maritime freight, and less use of packagings.

The quantity of water and energy used in the proposed methodology are equally lower and present advantages, when compared to the traditional processes, since in the production process thereof the leather passes several times through a rotary cylindrical reactor, called a drum, which is a great consumer of water and energy. Thus, with a smaller leather mass carried in its interior, said reactors become more efficient, reducing their operating times and the water consumption.

Another aspect which reinforces the sustainable characteristic of the proposed method, is related to the quantity of chemical products used in the process.

Since the yield of the leather produced with the method that is the object of the present invention is superior, to produce the same final product, such as for example an automotive seat, a smaller quantity of chemical products will be used. This aspect is further reinforced by the higher efficiency in the application of the chemical products in different steps of the process, since there exist chemical products specifically destined to the filling of the “less noble” regions, usually located at the lateral ends of the leather pieces, which in accordance with the proposed method, are completely or partially removed.

Another favorable characteristic related to the method now claimed refers to the ease in handling the pieces, since, due to being unitarily lighter, the handling thereof becomes considerably easier, helping the flow of the material through the production steps of the industry, where it is necessary to move the pieces to different points in the production process. In this manner, the ergonomic benefits brought to the professionals who handle the leather pieces, are extremely positive.

Another factor related to the proposed method is the possibility of distributing the surplus from the production of foodstuffs, generated from the leather scraps, which would be discarded during the conventional product improvement process, further adding the social sustainability aspect to the referred method.

Additionally, this new geometry favors the implementation of the automation in the entire production chain, making the tanning industry become more and more close to prominent industrial trends, such as the 4.0 industry.

The method now proposed is further adaptable to the use of certification and leather tracing systems, guaranteeing that the product is sustainable from its origin, for example allowing to verify references of the place of origin of the animals and whether these are functioning in accordance with the rules established for the animal welfare and in harmony with the best social and/or labor practices. The mapping of all these characteristics allows the leather to be traced from its origin.

Although the present invention has been particularly described with exemplifying references of the same, it will be understood by those skilled in the art that several changes in the form and in the details can be applied to the same without departing from the coverage or scope of the present invention.

1. A METHOD FOR CUTTING RAW LEATHER WITH OPTIMIZED GEOMETRY, comprising total or partial removal of parts of an original raw or tripe leather (A) piece comprising a head (3), feet (4) and belly (5), to obtain a resulting raw or tripe leather piece (B) comprising a loin (1) and a shoulder (2), wherein the total or partial removal is applied to raw leather, in a pre-fleshing process (i.2), or tripe leather, in a tripe leather (i.5) trimming process, still in the initial stage of a Wet Blue leather production process, such that the removed parts of the original raw or tripe leather piece (A) are leather coproducts free from chemical substances applied to the resulting raw or tripe leather piece (B) in a subsequent tanning phase of the Wet Blue leather production process.

2. The METHOD, according to claim 1, wherein the resulting raw or tripe leather piece (B) has a substantially trapezoid or quadrangular geometry, without the usual irregularities presented on the edges of the original raw or tripe leather piece (A), in the initial stage of the production process thereof.

3. The METHOD, according to claim 1, comprising a cutting range with a minimum geometry, wherein the head (3), feet (4) and belly (5) are completely removed.

4. The METHOD, according to claim 1, comprising a cutting range with a maximum geometry, wherein the head (3), feet (4) and belly (5) are partially removed.

5. The METHOD, according to claim 1, wherein the resulting raw or tripe leather piece (B) has a lower standard deviation of a break variable relative to the original raw or tripe leather piece (A).

6. The METHOD, according to claim 1, wherein generation of raw leather coproducts is increased in the order of magnitude of 1.210% relative to the traditional processes.

7. The METHOD, according to claim 6, wherein the raw leather coproducts do not include chemical products in the tanning phase.

8. A TABLE FOR CUTTING RAW LEATHER WITH OPTIMIZED GEOMETRY, according to claim 1, comprising a top (10) in trapezoid shape, supported by a support structure (40), the top (10) comprising a plurality of metallic strips (20) juxtaposed in parallel, longitudinally, at their lateral ends, each metallic strip (20) being positioned on a determined side having one pair on the diametrically opposite side of the top (10).

9. The TABLE FOR CUTTING RAW LEATHER WITH OPTIMIZED GEOMETRY, according to claim 8, wherein the plurality of metallic strips (20), diametrically opposite, are identified with markers (30) of the same color, characters, or digits, to allow symmetrical alignment of the original raw or tripe leather (A) piece, over the top (10).

10. The TABLE FOR CUTTING RAW LEATHER WITH OPTIMIZED GEOMETRY, according to claim 8 wherein gaps formed by the meeting of the metallic strips (20), form slots (21), which serve as guides for cutting knives, wherein the cutting knives are manual or pneumatic, which with the help of markers (30), enable the symmetrical cut of the original raw or tripe leather (A) piece.
